(19) United States
(12) Patent Application Publication
(10) Pub. No.: US 2026/0109290 A1
(43) Pub. Date: Apr. 23, 2026

(54) SEAT LIGHTING SYSTEM AND A SEAT

(71) Applicant: Adient US LLC, Plymouth, MI (US)

(72) Inventors: John GOMEZ, Howell, MI (US); Peter James LEITE, Plymouth, MI (US); Thomas GOULD, Brighton, MI (US); Joseph GASKO, Commerce Township, MI (US); Reinier SOLIVEN, Rochester, MI (US)

(21) Appl. No.: 19/365,319

(22) Filed: Oct. 22, 2025

Related U.S. Application Data
(60) Provisional application No. 63/710,108, filed on Oct. 22, 2024.

(51) Int. Cl. B60Q 3/233; B60N 2/58; B60Q 3/62; B60Q 3/74; F21V 3/06

(52) U.S. Cl. CPC B60Q 3/233; B60N 2/5891; B60Q 3/62; B60Q 3/74; F21V 3/0625

(57) ABSTRACT

A seat lighting system may have a trim cover for a seating surface. The seating surface may have at least one light-transmissive portion. The seat lighting system may also have at least one light source. The at least one light source may be adapted to transmit light through the at least one light-transmissive portion. A gap may exist between the at least one light source and the light-transmissive portion.

### FIELD

A device that relates to a seat lighting system and a seat is depicted and described.

### BACKGROUND

Vehicle interior lighting has traditionally been provided through overhead dome lamps, door-mounted lights, and footwell-mounted lights. While such methods may adequately illuminate general areas of the passenger compartment, they often fail to provide localized illumination, which can lead to a multitude of problems ranging from an unappealing aesthetic to a safety hazard.

Various attempts have been made to incorporate lighting features within vehicle seating, but all fall short of achieving a comfortable, aesthetically pleasing, safe experience for the seat occupant. Accordingly, there remains a need for a vehicle seat with built-in lighting that can provide a safe and comfortable experience for the occupant without sacrificing aesthetic appeal.

### SUMMARY

A seat lighting system may have a trim cover for a seating surface with at least one light-transmissive portion and at least one light source. The at least one light source may be adapted to transmit light through the at least one light-transmissive portion, and a gap may exist between the at least one light source and the light-transmissive portion.

The seat lighting system may have a trim layer between a cushioning material and the trim cover.

The at least one light transmissive portion of the seat lighting system may have a perforated material.

The perforated material may have a set of graduated perforations.

The at least one light-transmissive portion may be bonded to the trim cover.

The at least one light-transmissive portion may have a faux seam.

The trim cover may comprise an opening that may receive the at least one light source.

The at least one light source may be a flexible LED strip and may be located within a pocket in the seating foam.

The seat lighting system may have a light diffuser, and the light diffuser may be located within the seat gap.

The light diffuser may be attached to the at least one light source.

The light diffuser may be a translucent silicone diffuser.

The at least one light-transmissive portion may comprise a polyurethane material.

The at least one light-transmissive portion may comprise a pocket for the at least one light source.

The pocket of the at least one light-transmissive portion may be sewn to the trim cover.

The at least one light-transmissive portion may comprise a three-dimensionally shaped panel that may provide a contoured illuminated seating surface.

The trim cover may comprise an opening through which the at least one light-transmissive portion may extend.

The seat lighting system may have a cage that may be made of a flexible material, and the cage may provide a shape for the seating surface.

The cage may be a housing for the at least one light source.

The cage may be made of a plastic material.

A vehicle seat may have the seat lighting system.

### BRIEF DESCRIPTION OF THE DRAWINGS

FIG. 1 is a schematic perspective view of a vehicle;

FIG. 2 is a schematic top view of an interior of a vehicle;

FIG. 3 is a schematic perspective view of a vehicle seat;

FIG. 4A is a schematic cross-section view of a seat back side bolster;

FIG. 4B is a schematic cross-section view of a seat back side bolster;

FIG. 4C is a schematic cross-section view of a seat back;

FIG. 5A is a schematic cross-section view of a seat base;

FIG. 5B is a schematic cross-section view of a seat base;

FIG. 6A is a schematic perspective cross-section view of a light module pocketed in a cushioning material;

FIG. 6B is a schematic cross-section view of a light module pocketed in a cushioning material;

FIG. 6C is a schematic side view of a portion of a seat lighting system;

FIG. 6D is a schematic side view of a portion of a seat lighting system;

FIG. 7A is a schematic exploded view of a seat lighting system;

FIG. 7B is a schematic perspective view of a seat lighting system;

FIG. 7C is a schematic sectional view of a seat lighting system;

FIG. 8A is a schematic perspective view of a light module;

FIG. 8B is a schematic cross-section view of a seat back side bolster;

FIG. 9A is a schematic view of a vehicle seat;

FIG. 9B is a schematic detailed view of a seat lighting system.

### DETAILED DESCRIPTION

It is to be understood that the system may assume various alternative orientations and step sequences, except where expressly specified to the contrary. It is also to be understood that the specific devices and processes illustrated in the attached drawings and described in the following specification are simply exemplary embodiments of the concepts herein. Hence, specific dimensions, directions, or other physical characteristics relating to the embodiments disclosed are not to be considered as limiting, unless expressly stated otherwise.

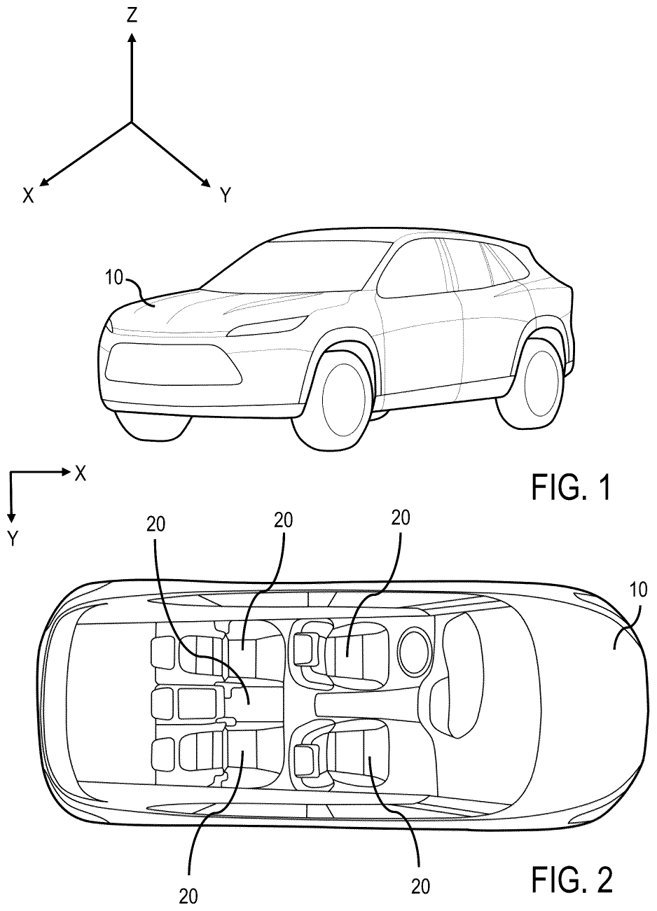

Turning now to FIG. 1, a vehicle 10 is schematically depicted. The vehicle 10 may be such as a land vehicle 10, but other vehicles 10 may be used as well. The vehicle 10 may be oriented in an X, Y, Z plane. The X axis may define a longitudinal direction and may be parallel to the typical direction of travel of the vehicle 10. The Y axis may define a lateral direction and may be perpendicular to the typical direction of travel of the vehicle 10 and parallel to the ground (not depicted) beneath the vehicle 10. The Z axis may be a vertical direction and may be perpendicular to both the X axis and Y axis.

As schematically depicted in FIG. 2, the vehicle 10 may have at least one vehicle seat 20. While multiple different seats 20 are shown, all seats 20 of the vehicle 10 may have a same size, shape, and features, or multiple seats 20 having different sizes, shapes, and features may be used as well.

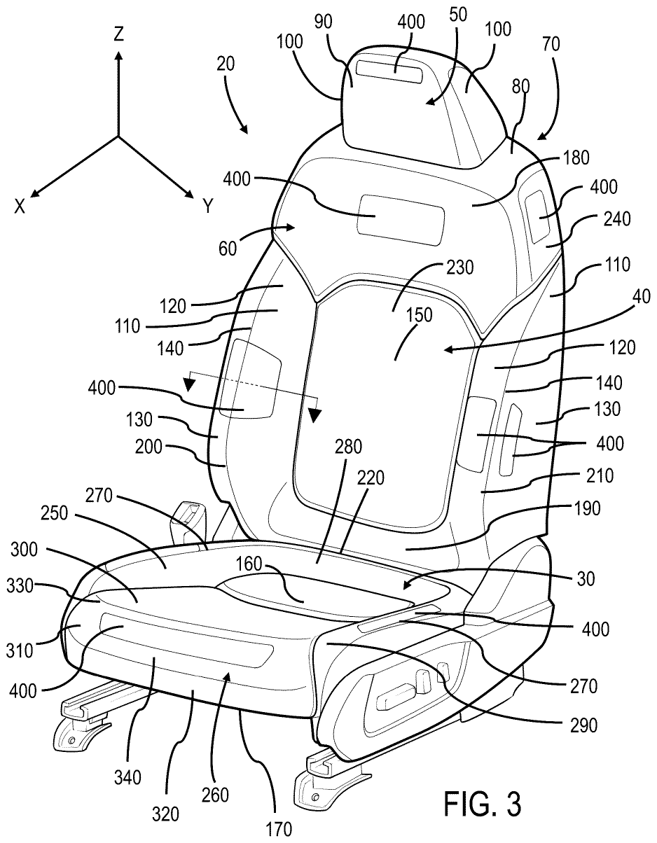

As schematically depicted in FIG. 3, the vehicle seat 20 may have a seat base 30 and a seat back 40 connected to the seat base 30. A headrest 50 may be connected to the seat back 40. The seat base 30, seat back 40, and headrest 50 may each have an outer surface 60 that an occupant (not depicted) of the vehicle seat 20 may contact during normal use of the vehicle seat 20.

The seat back 40 may be pivotable relative to the seat base 30. The seat back 40 may pivot in the longitudinal direction until the seat back 40 and the seat base 30 are in direct, facing contact with one another. This position may be defined as a closed position (not depicted). The seat back 40 may also pivot in the longitudinal direction until the seat back 40 is approximately 180 degrees from the seat base 30. This position may be defined as an open position (not depicted). While the open position and closed position are mentioned, the seat back 40 may assume any position between the closed position and the open position, which may be referred to as intermediate positions. One of the intermediate positions may be an upright position 70, which may describe a condition in which the seat back 40 is generally perpendicular to the seat base 30.

While a pivotable seat back 40 with an open position and a closed position is mentioned, the seat back 40 may not pivot at all or the seat back 40 may pivot beyond the open position or the closed position.

A lower portion (not depicted) of the headrest 50 may be in selective contact with an upper edge portion 80 of the seat back 40. The headrest 50 may be adjustable relative to the upper edge portion 80 of the seat back 40. For example, the headrest 50 may extend away from the upper edge portion 80 of the seat back 40 in the vertical direction.

The headrest 50 may be selectively attached to the seat back 40. The attachment of the headrest 50 to the seat back 40 may be achieved by any method necessary to secure the headrest 50 to the seat back 40 while maintaining the adjustability of the headrest 50 relative to the upper edge portion 80 of the seat back 40, but by way of example, the attachment may be achieved via prongs (not depicted) that extend vertically from the lower portion (not depicted) of the headrest 50 into respective openings (not depicted) in the upper edge portion 80 of the seat back 40.

The headrest 50 may comprise a front portion 90 and two side portions 100. The front portion 90 of the headrest 50 may be generally parallel to the lateral direction and generally perpendicular to the longitudinal direction, and the side portions 100 of the headrest 50 may be generally parallel to the longitudinal direction and generally perpendicular to the lateral direction. In other words, the front portion 90 of the headrest 50 may be generally perpendicular to the side portions 100 of the headrest 50. While a headrest 50 with distinct sides 100 is mentioned, the headrest 50 may be spherical or semi-spherical, or any other shape that does not comprise distinct sides 100.

The seat back 40 may have seat back side bolsters 110, such as on either side of a central portion 150 of the seat back 40. The seat back side bolsters 110 may be equally sized and shaped, or they may differ in size and shape. While one size, shape, and location of the bolsters 110 is depicted, others are permissible. Each seat back side bolster 110 may be substantially identical and therefore only one will be described herein.

The seat back side bolster 110 may have a front portion 120 and a side portion 130, and the front portion 120 and the side portion 130 may meet at an edge portion 140 of the seat back 40. The front portion 120 may extend from the central portion 150 of the seat back 40 to the edge portion 140 of the seat back 40 at an angle, such that the edge portion 140 may be longitudinally closer than a central portion 160 of the seat base 30 to a front edge portion 170 of the seat base 30. The side portion 130 of the seat back side bolster 110 may extend from the edge portion 140 of the seat back side bolster 110 at an angle laterally away from the central portion 150 of the seat back 40 and longitudinally away from the front edge portion 170 of the seat base 30.

The seat back 40 may have an upper portion 180 and a lower portion 190. The lower portion 190 may be vertically below the central portion 150 of the seat back 40 and extend from a first lateral edge 200 of the seat back 40 to a second lateral edge 210 of the seat back 40. While a lower portion 190 is mentioned, the central portion 150 of the seat back 40 and the seat back side bolsters 110 may extend to a vertically lower edge portion 220 of the seat back 40, in which case there may not be a distinct lower portion 190 of the seat back 40. The upper portion 180 of the seat back 40 may extend vertically from an upper portion 230 of the central portion 150 of the seat back 40 to the upper edge portion 80 of the seat back 40 at an angle such that the upper edge portion 80 of the seat back 40 may extend longitudinally towards the front edge portion 170 of the seat base 30. The upper portion 180 of the seat back 40 may have two side portions 240 which may be generally perpendicular to the upper portion 180 of the seat back 40 and generally parallel to the longitudinal direction.

The seat base 30 may comprise the central portion 160 of the seat base 30, a base bolster portion 250, and a front portion 260. The central base portion 160 may be at least partially surrounded by the base bolster portion 250 and the front portion 260. The base bolster portion 250 may comprise a general “U” shape, with two arms 270 and a base 280. The arms 270 and base 280 of the base bolster portion 250 may comprise an upper surface 290 and may extend vertically above the central portion 160 of the seat base 30 such that the central portion 160 of the seat base 30 may be vertically lower than the arms 270 and base 280 of the base bolster portion 250.

The front portion 260 of the seat base 30 may comprise three parts—a top portion 300, a transition portion 310, and a bottom portion 320. The top portion 300 of the front portion 260 of the seat base 30 may meet the transition portion 310 of the front portion 260 of the seat base 30 at a first front edge portion 330 of the front portion 260 of the seat base 30. The top portion 300 of the front portion 260 of the seat base 30 may extend longitudinally away from the central portion 160 of the seat base 30 at an angle until it reaches the first front edge 330 of the seat base 30 such that the first front edge 330 of the seat base 30 is vertically above the central portion 160 of the seat base 30. While an angled top portion 300 is mentioned, it may be the case that no such angle exists and the top portion 300 of the front portion 260 of the seat base 30 may lie in the same plane as the central portion 160 of the seat base 30. It may be the case that the top portion 300 of the front portion 260 of the seat base 30 extends longitudinally away from the central portion 160 of the seat base 30 at a negative angle, such that the first front edge 330 of the seat base 30 is vertically below the central portion 160 of the seat base 30. While the central portion 160 of the seat base 30 and the front portion 260 of the seat base 30 are mentioned, it may be the case that the central portion 160 of the seat base 30 and the front portion 260 of the seat base 30 are one, unitary portion.

The transition portion 310 of the front portion 260 of the seat base 30 may extend longitudinally and vertically away from the first front edge 330 of the front portion 260 of the seat base 30 until it reaches a second front edge 340 of the front portion 260 of the seat base 30. The transition portion 310 may extend away from the first front edge portion 330 of the front portion 260 of the seat 20 at an angle such that the second front edge portion 340 of the front portion 260 of the seat 20 may be vertically lower than the first front edge 330 of the front portion 260 of the seat base 30.

The bottom portion 320 of the front portion 260 of the seat base 30 may extend vertically away from the second front edge portion 340 of the front portion 260 of the seat base 30 at an angle such that the bottom portion 320 of the front portion 260 of the seat base 30 may be generally parallel to the vertical direction. The top portion 300, the transition portion 310, and the bottom portion 320 of the front portion 260 of the seat base 30 may be of equal lengths and widths, or they may be of unequal lengths and widths.

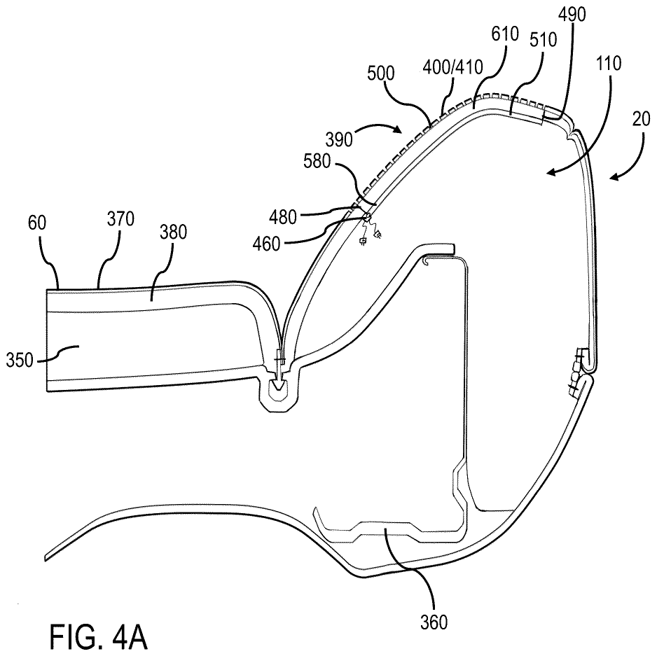

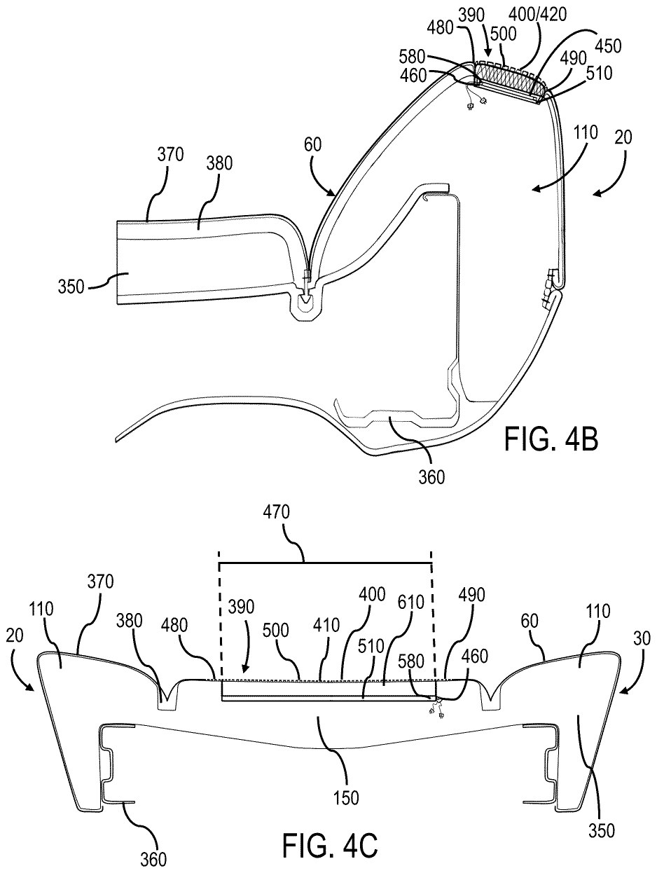

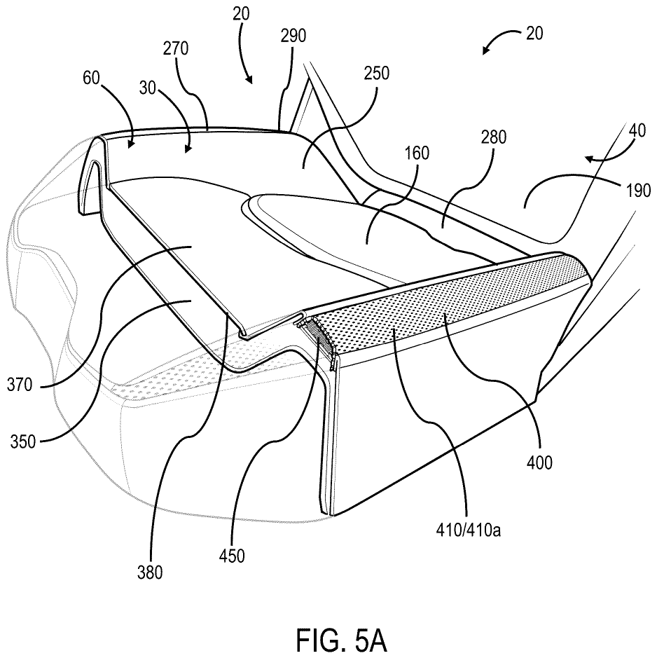

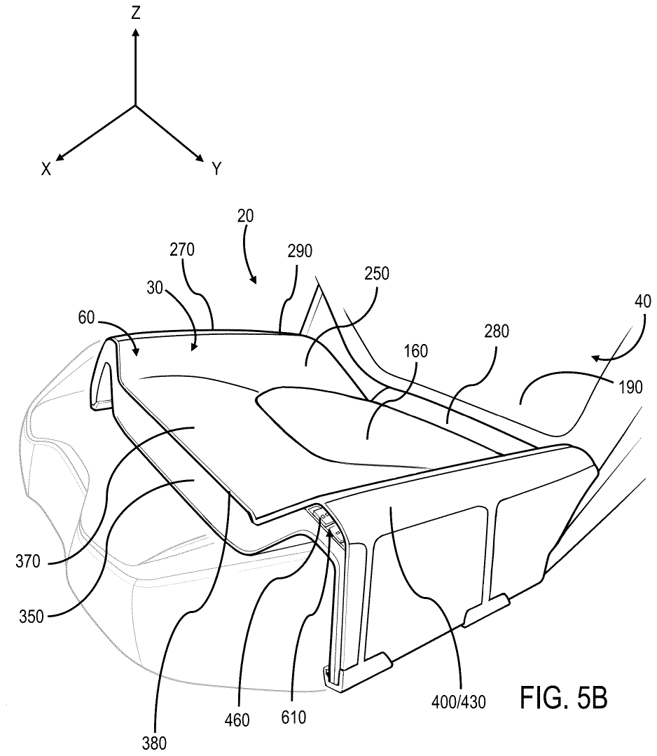

As schematically depicted in FIGS. 4a-5b, the seat 20 may be at least partially covered by a cushioning material 350. The cushioning material 350 may be a foam 350. While a foam 350 is mentioned, other cushioning materials 350 that may provide a comfortable experience for a seat 20 occupant may be used. The seat 20 may have cushioning material 350 of the same thickness throughout, or the seat 20 may have cushioning material 350 that may vary throughout. By way of example, the cushioning material 350 may be strategically placed about the seat 20 to maximize comfort of an occupant. The cushioning material 350 may be supported by a seat frame 360, as schematically depicted in FIGS. 4a-4c.

The cushioning material 350 on the seat 20 may be covered by a trim cover 370. The trim cover 370 may be made of any material capable of providing aesthetic appeal and functional benefits, but by way of example, the trim cover 370 may be made of leather or a textile fabric. The trim cover 370 may be of constant thickness, or it may vary in thickness. One continuous piece of trim cover 370 may be used to cover the entire seat 20, or multiple pieces of trim cover 370 may be used. For example, each portion of the seat 20 may comprise a separate piece or a number of separate pieces of trim cover 370.

As schematically depicted in FIG. 4a, a trim layer 380 may be located between the trim cover 370 and the cushioning material 350. The trim layer 380 may be made out of the same material as the trim cover 370, or the trim layer 380 may be made of a different material than the trim cover 370. The trim layer 380 may comprise a thickness, and the thickness of the trim layer 380 may be larger than a thickness defined by the trim cover 370. While a trim layer 380 with a greater thickness than the trim cover 370 is mentioned, there may be no trim layer 380 at all, or the trim layer 380 may be of equal or smaller thickness than the thickness of the trim cover 370. If the trim layer 380 is present, it may be present everywhere there is a trim cover 370, or it may only be present in some areas of the seat 20.

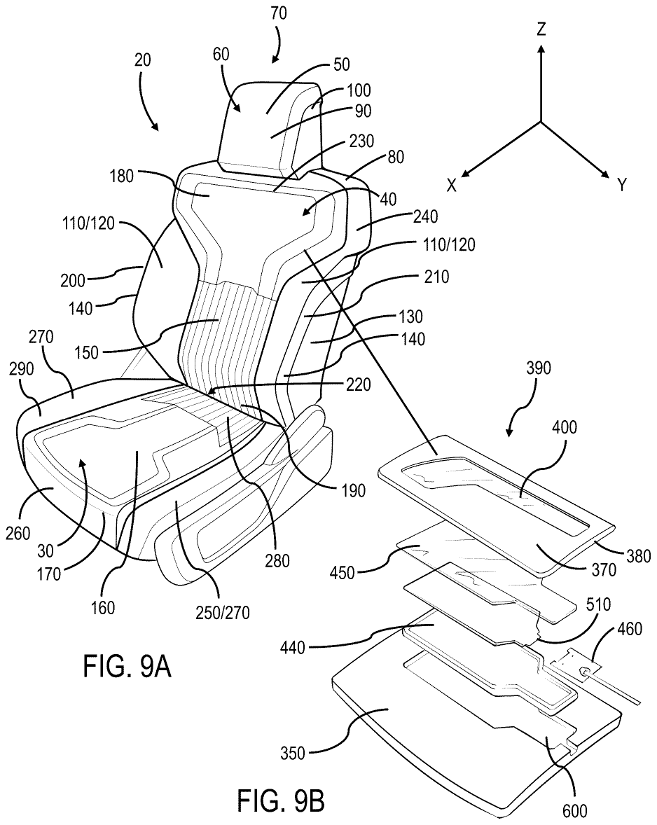

As schematically depicted in at least FIGS. 4a-4c and 9b, the seat 20 may comprise at least one light module 390. The light module 390 may comprise a light transmissive portion 400, a light diffuser 450, and a light source 460. While a light transmissive portion 400, a light diffuser 450, and a light source 460 are mentioned, the light module 390 may comprise only some of the aforementioned elements, or the light module 390 may comprise more elements than those listed above.

The light transmissive portion 400 may be bonded to the trim cover 370 on the vehicle seat 20. The at least one light transmissive portion 400 may extend through an opening 470 in the trim cover 370, and may be bonded to a first connecting portion 480 of the trim cover 370 and a second connecting portion 490 of the trim cover 370. The opening 470 in the trim cover 370 may be understood to mean a portion of the outer surface 60 of the seat 20 that does not comprise a trim cover 370. In other words, the opening 470 in the trim cover 370 may be defined as a distance between the first connecting portion 480 of the trim cover 370 and the second connecting portion 490 of the trim cover 370.

While one light transmissive portion 400 is mentioned, there may be multiple light transmissive portions 400 or no light transmissive portions 400 at all. The light transmissive portions 400 may be located on any part of the seat 20, but by way of example, as schematically depicted in FIG. 3, the light transmissive portion 400 may be located on the front portion 90 of the headrest 50, the side portions 100 of the headrest 50, the seat back upper portion 180 (as schematically depicted in FIG. 9a), the upper edge portion 80 of the seat back 40, the seat back upper portion side portion 240, the seat back central portion 150, the seat back side bolsters front portion 120, the seat back side bolsters side portion 130, the upper surface 290 of the seat base bolster portion 250, the top portion 300 of the front portion 260 of the seat base 30, the transition portion 310 of the front portion 260 of the seat base 30, and/or the bottom portion 320 of the front portion 260 of the seat base 30. The light transmissive portion 400 may be of any size and shape and may contain straight or curved lines. By way of example, the light transmissive portion 400 may be adapted to match the shape of the part of the seat 20 to which it is secured.

The at least one light transmissive portion 400 may comprise any material capable of allowing light to pass through. The at least one light transmissive portion 400 may comprise a perforated material 410 as schematically depicted in FIGS. 4a and 4c. The perforated material 410 may comprise a set of graduated perforations 410a, as schematically depicted in FIG. 5a. Graduated perforations 410a may be understood to mean perforations that may vary in size, shape, and spacing. While graduated perforations are mentioned, the perforations may be generally equal in size, shape, and spacing.

While a perforated material 410 is mentioned, the at least one light transmissive portion 400 may comprise a different material, such as a mesh material 420, as schematically depicted in FIGS. 4b and 5a. The mesh material 420 may be defined as a material made of a network of thread and may or may not comprise perforations.

While a perforated material 410 or a mesh material 420 is mentioned, the at least one light transmissive portion 400 may comprise a different material, such as a polyurethane material 430, as schematically depicted in FIG. 5b. The polyurethane material 430 may or may not comprise perforations.

The light transmissive portion 400 may comprise a three-dimensionally shaped panel 500 configured to provide a contoured illuminated seating surface. The three-dimensionally shaped panel 500 may be understood to define any of the aforementioned light transmissive portions 400. The light transmissive portion 400 may comprise a colored tint such that light may change color upon passing through the light transmissive portion 400.

The trim cover 370 may comprise an access portion (not depicted). The access portion may be adapted to receive the light source 460. The access portion may be located in the trim cover 370 near the light transmissive portion 400, or the access portion may be located distally from the light transmissive portion 400. The access portion may be of any size and shape capable of providing access to the light source 460, but by way of example, the access portion may be a small slit (not depicted) in the trim cover 370. The access portion (not depicted) may be left open such that the light source 460 may be removed at will, or the access portion may be closable via a closing mechanism such as a zipper (not depicted) or hook and loop fasteners (not depicted).

Each light transmissive portion 400 may correspond to at least one light source 460. The at least one light source 460 may be adapted to produce and transmit any agent that stimulates sight and increases visibility, such as a light, through the light transmissive portion 400 to which it corresponds. The light source 460 may be any light source 460 capable of emitting light, but by way of example, the light source 460 may comprise at least one LED 460. The light source may also be a flexible LED strip 460. The light source 460 may be coupled to an optic 510. The optic 510 may be generally parallel to the light transmissive portion 400 to which it corresponds. While an optic 510 is mentioned, the light source 460 may be used without an optic 510.

The light source 460 may be capable of emitting any color of light, but by way of example, the light source 460 may emit generic, visible lighting—similar to that of a standard diode. It may be possible for an occupant to change the color of the light being admitted by the light source 460 by a remote control (not depicted) or any other electronic means. The light source 460 may be of any size or shape necessary to fit the needs of the application, but by way of example, the light source 460 may be of equal length and width as the light transmissive portion 400 to which the light source 460 corresponds.

The light source 460 and the optic 510 may be flexible enough to fit the needs of the application. By way of example, the light source 460 and the optic 510 may be flexible enough to match the contours of the portion of the seat 20 to which it is attached. The light source 460 may transmit a light that is at least strong enough to pass through the light transmissive portion 400, but by way of example, the light source 460 may transmit a light of between approximately 50 lumens and 5000 lumens.

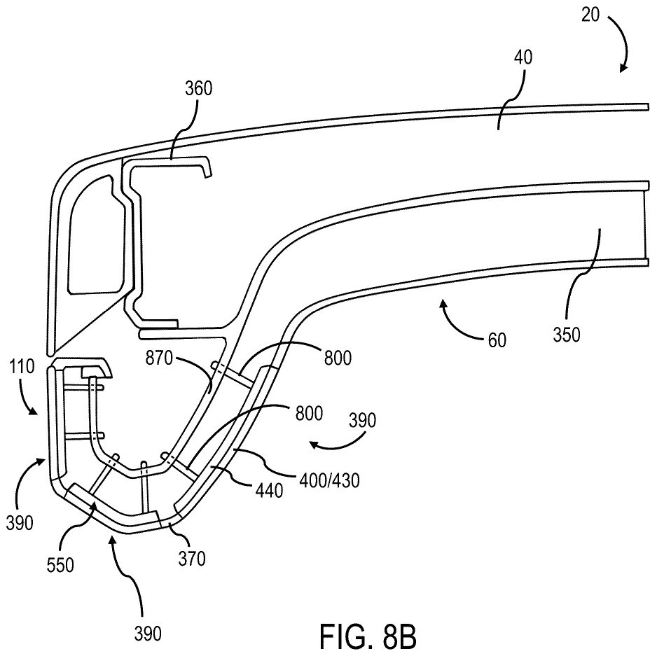

The at least one light source 460 and the optic 510 may be employed alone, or the at least one light source 460 and the optic 510 may be placed inside of a support portion 440 to support the at least one light source 460 and the optic 510, as schematically depicted in FIG. 8a. As the at least one light source 460 is described hereafter, it is to be understood that the at least one light source 460 may be placed within the support portion 440 without changing the purpose and/or effectiveness of the design.

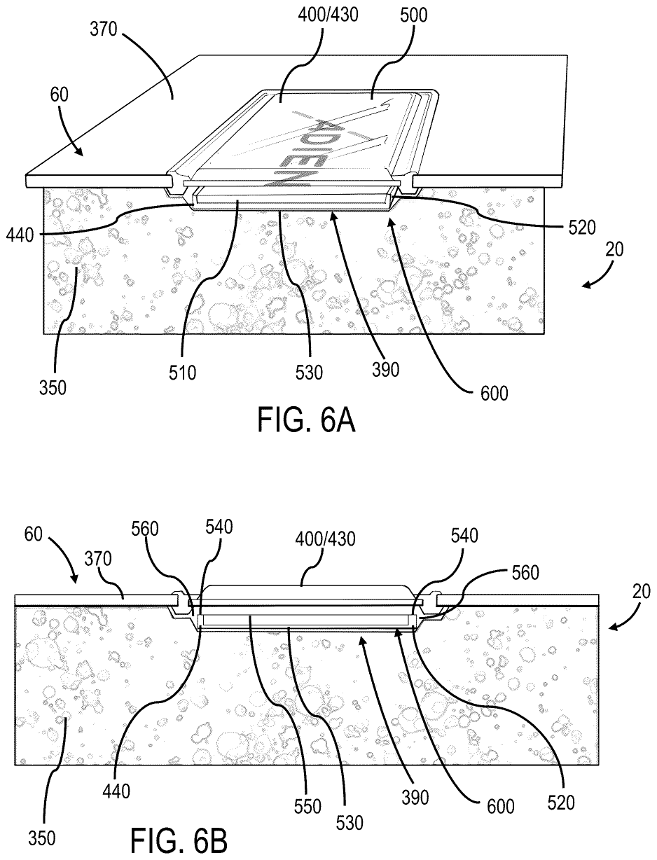

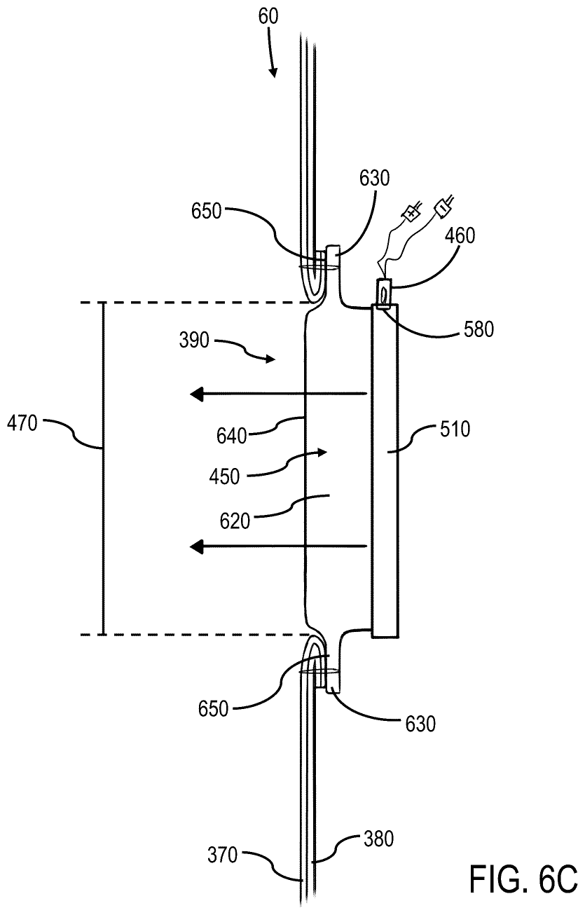

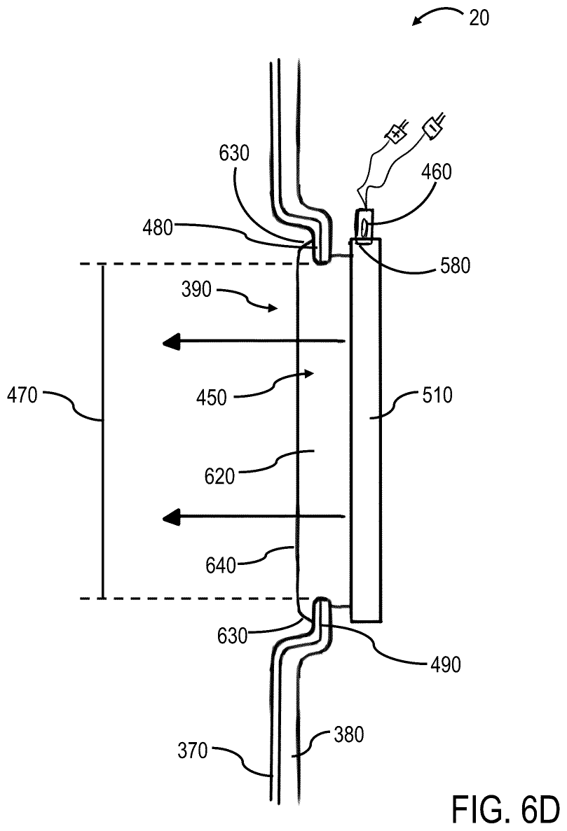

As schematically depicted in FIGS. 6a-6b, the support portion 440 may be generally bowl shaped with a side portion 520 and a bottom portion 530, and may be directly attached, such as by sewing, welding, or adhering, a top edge 540 of the side portion 520 to a hidden side 550 of the light transmissive portion 400. By way of example, welding the support portion 440 to the light transmissive portion 400 may be achieved by applying intense energy, such as through high-frequency welding, to the support portion 440 and an edge portion 560 of the light transmissive portion 400 at a point where the edge portion 560 of the light transmissive portion 400 and the support portion 440 are in contact, such that the edge portion 560 of the light transmissive portion 400 is encapsulated within the support portion 440.

While a direct attachment is mentioned, it may be that the support portion 440 of the light module 390 is in direct facing contact with the hidden side 550 of the light transmissive portion 400 without being directly affixed thereto. The support portion 440 may at least partially contain the at least one light source 460, the optic 510, and the at least one light diffuser 450. The at least one light source 460, the optic 510, and the at least one light diffuser 450 may be secured to an inner portion 570 of the support portion 440, such as by using adhesives, welding, sewing, or mechanical fasteners.

The optic 510 may be edge lit by the light source 460, such that only a first edge 580 of the optic 510 is equipped with lighting elements 590, such as diodes 590. While an edge lit optic 510 is mentioned, lighting elements 590 may be distributed evenly throughout the optic 510. The optic 510 may be adapted to evenly distribute light throughout the optic 510 even though the optic 510 may only have lighting elements 590 on the first edge 580. For example, the optic 510 may comprise lighting elements 590 on the first edge 580 of the optic 510, and when the at least one light source 460 is turned on, the light may originate on the first edge 580 of the optic 510, but may appear to an occupant as if the lighting elements 590 are evenly distributed throughout the at least one light source 460 due to the ability of the optic 510 to evenly distribute the light. The optic 510 may be made of any translucent material capable of evenly distributing light, but by way of example, the optic 510 may be made of a translucent silicone material.

The light source 460 may be powered by any method necessary to illuminate the light source 460, but by way of example, the light source 460 may be directly wired to an electrical system (not depicted) of the vehicle 10, or the light source 460 may be otherwise connected to the electrical system (not depicted) of the vehicle 10.

As schematically depicted in FIGS. 6a-6b, at least one pocket 600 may be located in the cushioning material 350. The pocket 600 may be adapted to house the support portion 440. The pocket 600 may be located at a depth in the cushioning material 350. The depth of the pocket 600 in the cushioning material 350 may be equal to a height of the light source 460, or the depth of the pocket 600 in the cushioning material 350 may be less than or greater than the height of the light source 460.

As schematically depicted in FIGS. 4a-4c and 5b, there may be a gap 610 between the light source 460 and the light transmissive portion 400. The gap 610 may comprise a thickness that may be generally equal to that of the trim layer 380. While a gap 610 and trim layer 380 of generally equal thickness is mentioned, it may be the case that the gap 610 and trim layer 380 have different thicknesses. By way of example, “generally equal thickness” may be understood to mean that the gap 610 and the trim layer 380 may have thicknesses that are within standard manufacturing tolerances.

While a gap 610 is mentioned, it may be the case that no gap 610 exists, and the light source 460 sits in direct facing contact with the light transmissive portion 400, or the gap 610 may be larger or smaller than the trim layer 380 in width. If a gap 610 does exist, the gap 610 may be empty, or it may comprise the light diffuser 450, as shown in FIG. 4b.

The light diffuser 450 may be directly attached to the light source 460, or it may rest on the light source 460 with no direct attachment. The light diffuser 450 may be of any size or shape capable of fitting between the light source 460 and the light transmissive portion 400, but by way of example, the light diffuser 450 may comprise a generally rectangular cross section. The light diffuser 450 may extend over the entire light source 460, or the light diffuser 450 may extend over only a portion of the light source 460. The light diffuser 450 may comprise any translucent material, but by way of example, the light diffuser 450 may be a polyurethane diffuser 450, a mesh diffuser 450, or a silicone diffuser 450.

As schematically depicted in FIGS. 6c-6d, it may be possible that there is no light transmissive portion 400 associated with the light source 460. In such a case, the light diffuser 450 may have a central portion 620 and two connector portions 630 at opposite ends of the central portion 620. The light diffuser 450 may extend from the light source 460 until a top surface 640 of the central portion 620 of the light diffuser 450 is generally aligned with the trim cover 370. In other words, the top surface 640 of the central portion 620 of the light diffuser 450 may become part of the outer surface 60 of the vehicle seat 20 such that an occupant may contact the top surface 640 of the central portion 620 of the light diffuser 450 during typical use. The two connector portions 630 may be sewn to the trim cover 370 at an upper edge 650 of each connector portion 640. While a sew is mentioned, the two connector portions 630 may be sewn, welded, adhered, or otherwise attached to the trim cover 370. The upper edge 650 of the connector portions 630 of the light diffuser 450 may be slightly offset from the top surface 640 of the central portion 620 of the light diffuser 450 such that when the trim cover 370 is sewn to the connector portions 630, the trim cover 370 and the top surface 640 of the central portion 620 of the light diffuser 450 are generally flush. While a flush top surface 640 of the central portion 620 of the light diffuser 450 and trim cover 370 is mentioned, the top surface 640 of the central portion 620 of the light diffuser 450 may sit below or above the trim cover 370.

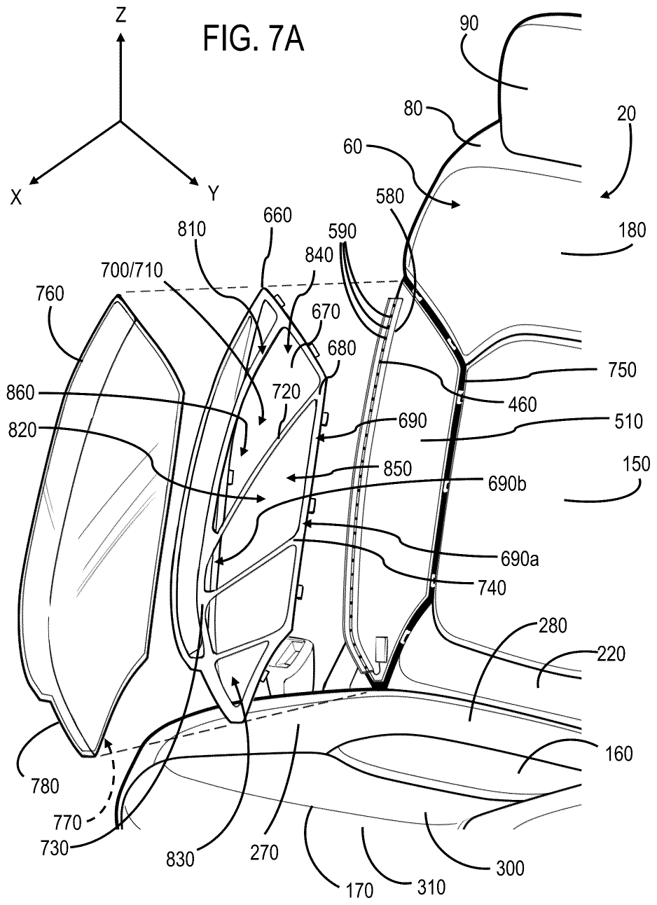

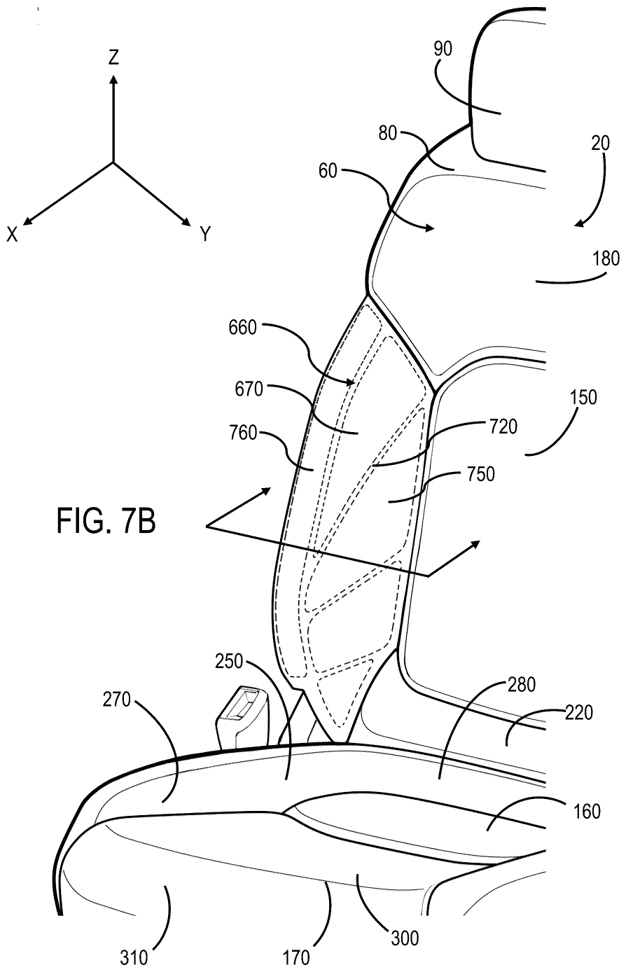

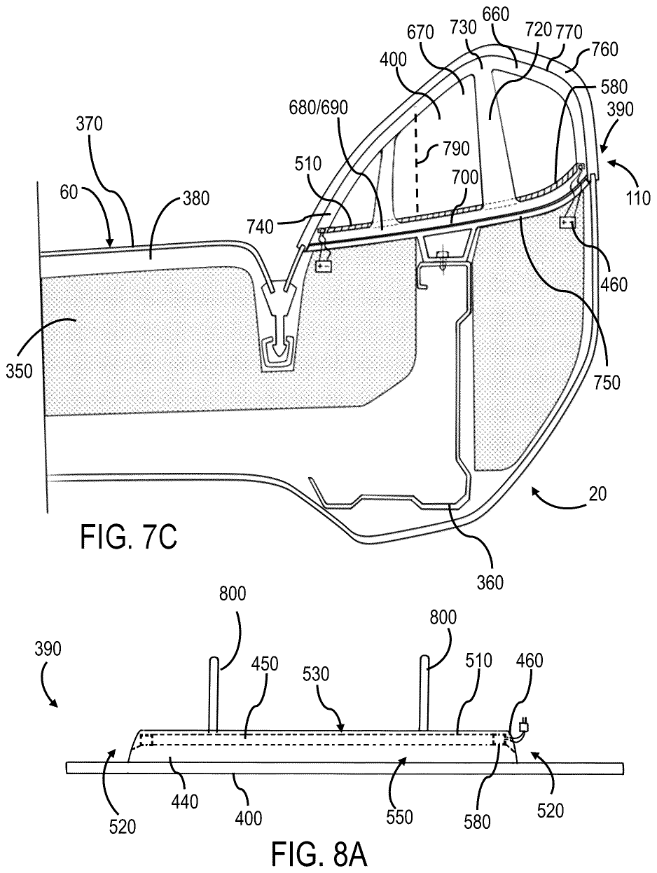

As schematically depicted in FIGS. 7a-7c, a portion of the seat 20 and/or a portion of the light module 390 may comprise a cage 660. The cage 660 may make up an entire portion of the seat 20, such as an entire seat back side bolster 110, or it may make up only a partial portion of the seat 20. Every portion of the seat 20 may comprise at least one cage 660, but by way of example, the seat back side bolsters 110 and the seat base bolster portion 250 may each comprise at least one cage 660. While at least one cage 660 may be associated with every portion of the vehicle seat 20, it may be that only one portion of the seat 20 comprises a cage 660, multiple portions of the seat 20 comprise a cage 660, or no cage 660 is present at all. The cage 660 may be adapted to take the shape of the portion of the seat 20 which it comprises. For example, if the seat back side bolster 110 comprises the cage 660, the cage 660 may have the same shape as a typical seat back side bolster 110 would. By way of another example, if the headrest 50 comprises a cage 660, the cage 660 may have the same shape as a typical headrest 50 would.

The cage 660 may be flexible and at least partially elastically deformable such that the cage 660 is capable of at least partially collapsing in on itself without permanent deformation. The cage 660 may be made of any material capable of achieving these characteristics, but by way of example, the cage 660 may be made of an elastomeric, plastic material. The cage 600 may be convex and skeleton-like with the light transmissive portions 400 as described above that allow light to shine through the cage 600, such as through openings 670 in the cage 660.

Describing the cage 660 as “skeleton-like” may be understood to mean a cage 660 that may comprise a base portion 680 that may have a perimeter 690. The perimeter 690 may be adapted to generally match a perimeter of the portion of the seat 20 which comprises the cage 660. The perimeter 690 of the cage 660 may comprise different perimeter portions 690a, 690b, such as a first perimeter portion 690a and a second perimeter portion 690b. While a first perimeter portion 690a and a second perimeter portion 690b are mentioned, there may be more or fewer perimeter portions 690a, 690b. The base portion 680 may comprise just the perimeter 690 of the base portion 680 such that a center portion 700 of the base portion 680 of the cage 660 comprises a gap 710 between the perimeter portions 690a, 690b of the base portion 680. While a base portion 680 with a center portion 700 comprising just a gap 710 is mentioned, the center portion 700 of the base portion 680 of the cage 660 may alternatively comprise a connector portion (not depicted), which may connect the different perimeter portions 690a, 690b to one another along the base portion 680.

At least one rib 720 may extend from one perimeter portion 690a, 690b of the base portion 680 to another portion 690a, 690b of the perimeter 690 of the base portion 680. The at least one rib 720 may be generally arched such that the at least one rib 720 comprises a high point 730 and two low points 740. Each low point 740 may be integrally formed with the perimeter portion 690a, 690b of the base portion 680 to which the at least one rib 720 extends from, and the high point 730 may defined as a point along the at least one rib 720 that is furthest away from the base portion 680. While at least one rib 720 is mentioned, by way of example, the cage 660 may comprise a number of ribs 720, as schematically depicted in FIGS. 7a-7c.

The cage 660 may comprise the openings 670 between the number of ribs 660 of the cage 660 with no material. The openings 670 may have a total area that equals a greater share of the total area of the cage 660 than the ribs 720 and the base portion 680, or the ribs 720 and the base portion 680 may have a total area that equals a greater share of the total area of the cage 660 than the openings 670.

The cage 660 may be directly connected to a support panel 750 at the base portion 680 of the cage 660. The connection may be any capable of fixing the cage 660 to the support panel 750, but by way of example, the connection may be achieved via stitching, welding, adhering, or snap-fitting the cage 660 to the support panel 750. The light source 460 may be directly attached, such as adhered, to the support panel 750. While adhering is mentioned, the light source 460 may be attached to the support panel 750 by any method necessary to fix the light source 460 to the support panel 750 without hindering the ability of the light source 460 to emit light. When fully assembled, the cage 660 may be said to be a housing for the at least one light source 460. In other words, the cage 660 may at least partially surround the at least one light source 460.

The light source 460 may cover the entire support panel 750, or the light source 460 may cover only a portion of the support panel 750. As schematically depicted in FIG. 7a, the light source 460 may comprise a flexible LED strip 460 and an optic 510 as previously mentioned, and the flexible LED strip 460 may provide edge lighting to the optic 510, which may be adapted to distribute the light evenly throughout the optic 510.

The cage 660 may be at least partially surrounded by a cage cover 760, which may be said to be the light transmissive portion 400 of the cage 660. The cage cover 760 may be flexible and translucent, such that the cage cover 760 is comfortable for an occupant of the seat 20 and capable of allowing light to pass through. The cage cover 760 may be supported by the cage 660 and may be directly connected to the cage 660.

Specifically, an underside 770 of the cage cover 760 may be directly connected to an outer portion 810 of the cage 660. The connection may be achieved by any method necessary to secure the cage cover 760 to the cage 660, but by way of example, the connection may be achieved via adhesives, welding, or stitching. The cage cover 760 may be the same shape as the cage 660, may be convex, and may be slightly larger than the cage 660 such that outer edge portions 780 of the cage cover 760 may align with the perimeter 690 of the base portion 680 of the cage 660 when the cage cover 760 and the cage 660 are attached. The cage cover 760 may comprise a colored tint such that the light emitted from the light source 460 may change color upon passing through the cage cover 760.

There may be a gap 790 between the cage 660 and the light source 460. Due to the convex nature of the cage 660, the gap 790 may be smaller near the perimeter portions 690a, 690b of the cage 660 and may become gradually larger towards a middle portion 820 of the cage 660. While a larger gap 790 towards the middle portion 820 of the cage 660 is mentioned, the gap 790 may be larger towards a bottom portion 830, a top portion 840, a first side portion 850, or a second side portion 860 of the cage 660, depending on the needs of the application.

As schematically depicted in FIGS. 8a-8b, the at least one light module 390 may further comprise at least one connector portion 800. While one connector portion 800 is mentioned, two or more connector portions 800 may be used. The at least one connector portion 800 of the light module 390 may be a rod that may extend at an angle, such as an angle of 60-degrees to 120-degrees, from the bottom portion 530 of the support portion 440 away from the hidden side 550 of the light transmissive portion 400. While an angle of 60-degrees to 120-degrees is mentioned, any angle necessary to fit the needs of the application may be used. The at least one connector portion 800 of the at least one light module 390 may extend from the support portion 440 of the at least one light module 390 to apertures (not depicted) in an internal seat support substrate 860, to which the at least one connector portion 800 may be attached and secured. The at least one connector portion 800 may support the light module 390 and the light transmissive portion 400 and may connect the at least one light module 390 to a power source (not depicted), such as the battery (not depicted) of the vehicle 10 and/or the electrical system (not depicted) of the vehicle 10. When the at least one connector portion 800 is present, there may not be the gap 610 between the light module 390 and the light transmissive portion 400. In such a case, the light module 390 may be in direct facing contact with the light transmissive portion 400.

The at least one light module 390 may be operatively connected to the battery (not depicted) or the electrical system (not depicted) of the vehicle 10 such that when an occupant turns the vehicle 10 on, the battery (not depicted) turns on, and the at least one light module 390 receives power from the battery (not depicted). Upon receiving power from the battery (not depicted), the at least one light module 390 may automatically light up, or the at least one light module 390 may remain unlit, giving the occupant the option to turn the lights on manually or keep them unlit.

When the light module 390 is turned on turned on, light may pass from the light source 460, through the light diffuser 450, and through the light transmissive portion 400 to create a visually appealing effect.

In accordance with the provisions of the patent statutes, the present device and/or method has been described in what is considered to represent its preferred embodiments. However, is should be noted that the present device and/or method can be practiced otherwise than as specifically illustrated and described without departing from its spirit or scope.

What is claimed is:

1. A seat lighting system, comprising:
a trim cover for a seating surface, comprising at least one light-transmissive portion, and
at least one light source,
wherein the at least one light source is adapted to transmit light through the at least one light-transmissive portion, and
wherein a gap exists between the at least one light source and the light transmissive portion.

2. The seat lighting system of claim 1, wherein a trim layer is between a cushioning material and the trim cover.

3. The seat lighting system of claim 1, wherein the at least one light transmissive portion comprises a perforated material.

4. The seat lighting system of claim 3, wherein the perforated material comprises a set of graduated perforations.

5. The seat lighting system of claim 1, wherein the at least one light-transmissive portion is bonded to the trim cover.

6. The seat lighting system of claim 1, wherein the at least one light-transmissive portion comprises a faux seam.

7. The seat lighting system of claim 1, wherein the trim cover comprises an opening that is adapted to receive the at least one light source.

8. The seat lighting system of claim 1, wherein the at least one light source is a flexible LED strip and is located within a pocket in the seat foam.

9. The seat lighting system of claim 1, wherein a light diffuser is located within the gap.

10. The seat lighting system of claim 9, wherein the light diffuser is attached to the at least one light source.

11. The seat lighting system of claim 9, wherein the light diffuser is a translucent silicone diffuser.

12. The seat lighting system of claim 1, wherein the at least one light-transmissive portion comprises a polyurethane material.

13. The seat lighting system of claim 1, wherein the at least one light-transmissive portion comprises a pocket for the at least one light source.

14. The seat lighting system of claim 13, wherein the pocket is sewn to the trim cover.

15. The seat lighting system of claim 1, wherein the at least one light-transmissive portion comprises a three-dimensionally shaped panel configured to provide a contoured illuminated seating surface.

16. The seat lighting system of claim 1, wherein the trim cover comprises an opening through which the at least one light-transmissive portion extends.

17. The seat lighting system of claim 1, further comprising a cage made of a flexible material, wherein the cage is adapted to provide a shape for the seating surface.

18. The seat lighting system of claim 17, wherein the cage is a housing for the at least one light source.

19. The seat lighting system of claim 17, wherein the cage is made of a plastic material.

20. A vehicle seat adapted for use with the seat lighting system of claim 1.
